(19) United States
(12) Patent Application Publication
(10) Pub. No.: US 2010/0112391 A1
(43) Pub. Date: May 6, 2010

(54) COUNTER-FLOW MEMBRANELESS FUEL CELL

(75) Inventors: Kamil SALLOUM, Scottsdale, AZ (US); Jonathan Posner, Tempe, AZ (US)

Correspondence Address: PILLSBURY WINTHROP SHAW PITTMAN, LLP, P.O. BOX 10500, MCLEAN, VA, 22102, US

(73) Assignee: Arizona Board of Regents for and on behalf of Arizona State University, Tempe, AZ (US)

(21) Appl. No.: 12/609,614

(22) Filed: Oct. 30, 2009

Related U.S. Application Data
(60) Provisional application No. 61/193,157, filed on Oct. 31, 2008.

(51) Int. Cl. H01M 8/04; H01M 8/00; H01M 2/00

(52) U.S. Cl. 429/14; 429/13; 429/34

(57) ABSTRACT

A method for generating electrical current using a fuel cell includes flowing a first flow that includes a fuel and an electrolyte through a first channel. The fuel is oxidized at an anode to generate electrons for conduction to a load and oxidation products that remain in the first flow. The method includes flowing a second flow that includes an oxidizer and an electrolyte through a second channel that is open to the first channel. A cathode receives electrons from the load and the oxidation products, and the oxidizer is reduced to form reduction products and complete an electrochemical circuit. The plurality of exchange zones are positioned and the flows are oriented within their respective first and second channels such that the first and second flows contact one another intermittently at the exchange zones to enable transport of the reduction and oxidation products to the anode and cathode.

### CROSS-REFERENCE TO RELATED APPLICATIONS

This application claims the benefit of priority from U.S. Provisional Patent Application No. 61/193,157, filed Oct. 31, 2008, the entire content of which is incorporated herein by reference.

### FIELD OF THE INVENTION

The present application relates to a fuel cell, and more particularly a membraneless fuel cell wherein a flow of reductant and oxidant are provided to a transport zone in which ions are exchanged and the reductant and oxidant undergo oxidation and reduction, respectively.

### BACKGROUND OF THE INVENTION

If fuel cells are to become viable portable power sources in the future, solutions to a number of difficult, persistent technical problems are needed. Many of these problems are associated with the presence of the proton exchange membrane, which is highly sensitive to various factors, such as operating temperatures and membrane humidity. Efforts in portable applications have largely focused on reducing the size of proton exchange membrane (PEM) fuel cells. By portable power sources, this is generally referring to substitutes for batteries that power portable electronic devices. This approach carries all the cost and efficiency issues associated with larger scale PEM fuel cells. Moreover, the reduction in size exaggerates some of these problems, and introduces even further problems that require resolution for a commercially viable product.

One approach has been to deliver parallel co-laminar flows of oxidizer and fuel saturated electrolytes into a single channel with a cathode on one side and an anode on another. See, e.g., Membraneless Vanadium Redox Fuel Cell Using Laminar Flow, Ferrigno et al., J. Amer. Chem. Soc. 2002, 124, 12930-12931; Fabrication and Preliminary Testing of a Planar Membraneless Microchannel Fuel Cell, Cohen et al., J. Power Sources, 139, 96-105; and Air-Breathing Laminar Flow-Based Microfluidic Fuel Cell, Jayashree et al., J. Am. Chem. Soc., 2005, 127, 16758-16759. See also, U.S. Pat. Nos. 7,252,898 and 6,713,206. Each of these is incorporated into the present application by reference in their entirety for background teachings.

This approach has various shortcomings. First, the fuel and oxidizer will mix downstream of the entry point, wasting the majority of the fuel. Second, the diffusivity of many oxidizers leads to mixed potentials at the anode due to oxidizer cross-over to the anode. This takes energy away from the circuit and also leads to inefficiency of the overall cell. Third, a mass transport boundary layer builds up on the electrodes which generates mass transport losses in the fuel cell and decreases performance. Fourth, the architecture of the cell is restricted to the geometries, length scales, and electrolytes where laminar flow is ensured.

U.S. Patent Publication Nos. 2003/0165727 and 2004/0058203 disclose mixed reactant fuel cells where the fuel, oxidant and electrolyte are mixed together and then flow through the anode and cathode. These publications are incorporated herein by reference. According to these publications, the anode is allegedly selective for fuel oxidation and the cathode is allegedly selective for oxidizer reduction. The designs in these publications have significant shortcomings. First, the amount of some oxidizers that can be typically carried by an electrolyte is relatively low (e.g., the oxygen solubility in an electrolyte is typically quite low relative to fuel solubility). This means that a relatively high flow rate is required for the mixed reactants to ensure that an ample amount of oxidizer is flowing through the cell. That is, a relatively high flow rate is required to maximize oxidizer exposure and reaction at the cathode. But increasing the flow rate requires increased work, thus detracting from the overall power efficiency of the cell. Increasing the flow rate also advects the reactants downstream before they can fully react, resulting wasted reactants. Moreover, electrodes that are selective by virtue of their material properties tend to have lower reaction activity rates than non-selective electrodes. Because the designs in these two publications rely primarily on the use of selective electrodes for both the cathode and anode, this further detracts from the efficiency of the cell.

The present application addresses the aforementioned challenges without a proton exchange membrane.

### SUMMARY OF THE INVENTION

According to an aspect of the present invention, there is provided a method for generating electrical current using a fuel cell comprising an anode, a cathode, a first flow channel associated with the anode, a second flow channel associated with the cathode, and a plurality of spaced apart exchange zones wherein the first and second flow channels are open to one another. The method includes flowing a first flow comprising a fuel and a first electrolyte through the first channel. The fuel is oxidized at the anode to generate electrons for conduction to a load and oxidation products in the first flow. The method includes flowing a second flow that includes an oxidizer and a second electrolyte through the second channel. The cathode receives electrons from the load and the oxidation products, and the oxidizer forms reduction products to complete an electrochemical circuit. The plurality of exchange zones are positioned and the flows are oriented within their respective first and second channels such that the first and second flows contact one another intermittently at the exchange zones to enable transport of the reduction and oxidation products to the anode and the cathode.

According to an aspect of the invention, there is provided a fuel cell that includes an anode configured to be connected to a load, a cathode configured to be connected to the load; and a first flow channel associated with the anode, and configured to receive a flow of a fuel and a first electrolyte so that, in use, the fuel is oxidized by the anode to generate electrons for conduction to the load and oxidation products in the first electrolyte. The fuel cell also includes a second flow channel associated with the cathode, and configured to receive a flow of an oxidizer and a second electrolyte so that, in use, the oxidizer is reduced by its reaction with the oxidation products and incoming flux of electrons from the load to form reduction products, and a plurality of spaced apart exchange zones wherein the first and second flow channels are open to one another. The first and second flow channels are oriented such that the flow of the fuel and first electrolyte and the flow of the oxidizer and the second electrolyte within their respective first and second channels contact one another intermittently.

Other aspects, features, and advantages of the present invention will become apparent from the following detailed description, the accompanying drawings, and the appended claims.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 is a schematic view of a fuel cell in accordance with an embodiment of the present invention;

FIG. 2 is a schematic view of a fuel cell in accordance with an embodiment of the present invention;

FIG. 3 is a schematic view of Detail A of FIG. 1;

FIG. 4 is a schematic view of Detail B of FIG. 2;

FIG. 5 is a schematic view of an embodiment of a portions of the fuel cell of FIG. 2;

FIG. 6 is a schematic cross-sectional view of a fuel cell according to an embodiment of the present invention;

FIG. 7 is a schematic cross-sectional view of the fuel cell of FIG. 6, with the cross-section being taken about 90° relative to the cross-section of FIG. 6;

FIG. 8 is a top perspective view of a portion of the fuel cell of FIGS. 6 and 7;

FIG. 9 is a schematic view of the flow of anode reactants and cathode reactants through the fuel cell of FIGS. 6 and 7; and

FIG. 10 is a schematic cross-sectional view of a fuel cell according to an embodiment of the present invention.

### DETAILED DESCRIPTION OF EMBODIMENTS OF THE INVENTION

The Figures illustrate several embodiments of various aspects of the inventions claimed. These embodiments are in no way intended to be limiting, and are intended only as an example for facilitating an understanding of the principles of the claimed inventions. In some instances, various components are illustrated schematically, as it is understood many different structures may be used.

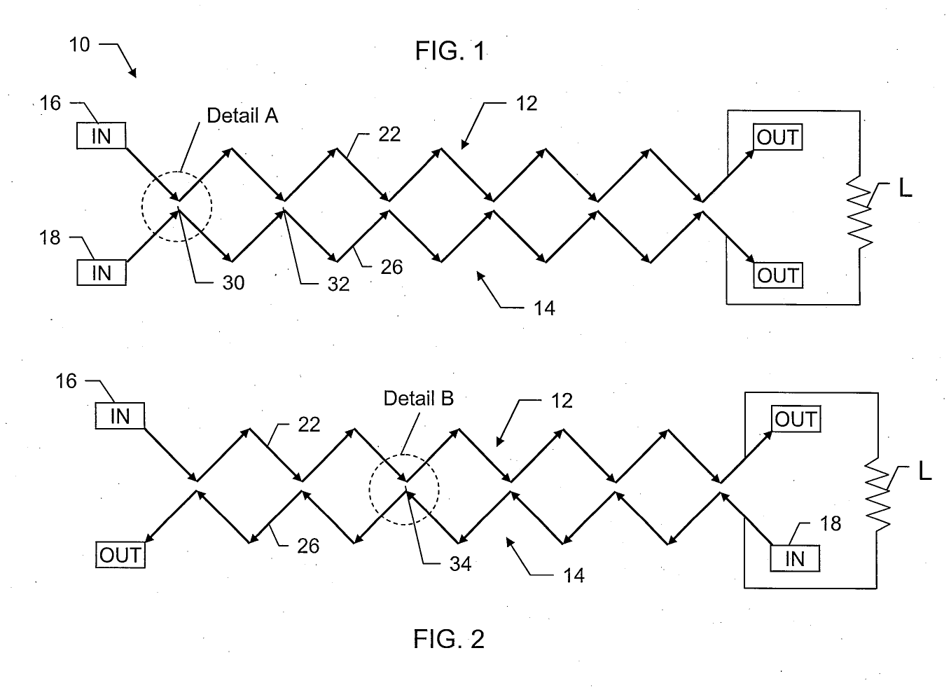

In the illustrated embodiment of FIG. 1, a fuel cell system is generally indicated at 10. The fuel cell system 10 has an anode 12 and a cathode 14 that are each connected to a load L. The anode 12 and the cathode 14 may be solid in embodiments where the respective fluids flow across or along the anode and the cathode, or may be wholly or partially porous in embodiments where the respective fluid flow through the anode and the cathode, as discussed in further detail below. The system 10 also includes a fuel source 16 configured to supply a fuel, which may be mixed with an electrolyte, an oxidizer source 18 configured to supply an oxidizer, which may be mixed with an electrolyte.

The fuel source 16 is connected to a first fluid passageway 22 and is configured to supply the fuel to the first fluid passageway 22. The fuel may be fed to the first fluid passageway 22 by gravity, surface forces, such as surface tension or electroosmotic flow, or a fuel flow generator, such as a pump, may be used to generate flow of the fuel through the first fluid passageway 22.

Similarly, the oxidizer source 18 is connected to a second fluid passageway 26 and is configured to supply the oxidizer to the second fluid passageway 26. The oxidizer may be fed to the second fluid passageway 26 by gravity, surface forces, such as surface tension or electroosmotic flow, or an oxidizer flow generator, such as a pump, may be used to generate flow of the oxidizer through the first fluid passageway 26.

The first fluid passageway 22 may be defined by a channel or conduit that is in contact with or defines the anode 12. The anode 12 may comprise a catalyst that is configured to catalyze the fuel so that the fuel is oxidized into at least oxidized fuel ions and electrons for conduction by the anode 14 to the load L. An oxidation product is an ionic or molecular byproduct of the fuel's oxidation that has donated at least one electron. An oxidation product may also be referred to as a cation because the loss of an electron may result in a positive charge. However, the cations may be supported in the electrolyte by negative ions. Non-limiting examples of catalysts that may be used include platinum, ruthenium, palladium, nickel, gold, and carbon or alloys of the aforementioned. The first fluid passageway 22 is preferably designed so that the flow of the fuel and electrolyte, which may be referred to as an anolyte, in the passageway 22 is a laminar flow.

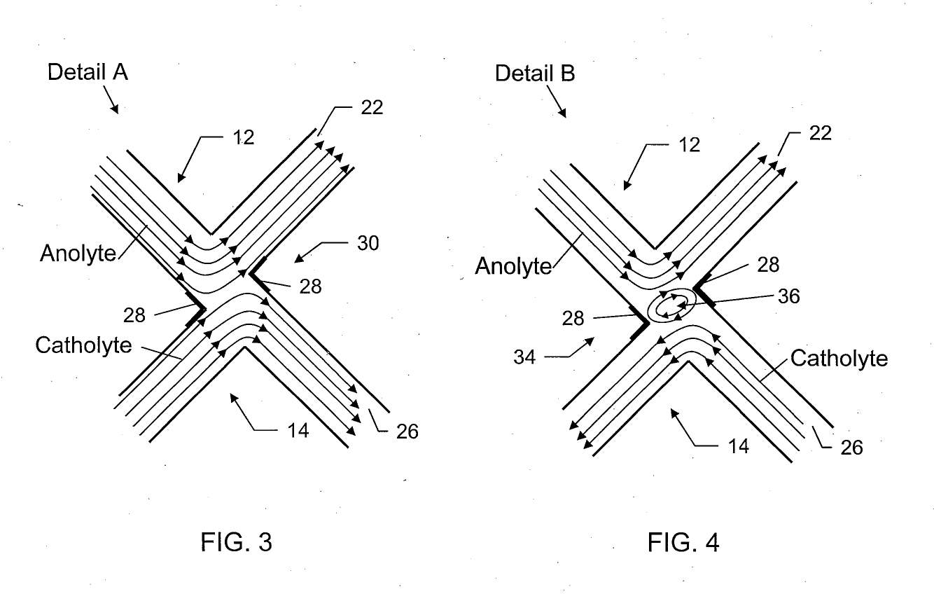

Similarly, the second fluid passageway 26 may be defined by a channel or conduit that is in contact with or defines the cathode 14. The cathode 14 receives electrons from the load L and may comprise a catalyst that is configured to catalyze the oxidizer so that the oxidizer is reduced into at least reduced products. A reduced product is an ionic or molecular byproduct of the oxidizer that has gained at least one electron. A reduced product may also be referred to as an anion because the gain of an electron may result in a negative charge. However, the anions may be supported in the electrolyte by positive ions. Non-limiting examples of catalysts that may be used include platinum, ruthenium, palladium, nickel, gold, and carbon or alloys of the aforementioned. Like the first fluid passageway 22, the second fluid passageway 26 is preferably designed so that the flow of the oxidizer and electrolyte, which may be referred to as a catholyte, in the passageway 26 is a laminar flow. The fuel cell 10 also includes an insulator 28, as schematically shown in FIG. 3, that is located between the anode 12 and the cathode 14. The insulator 28 is configured to prevent a short-circuit between the anode 12 and the cathode, i.e., prevent the anode 12 and the cathode 14 from directly conducting electrons between each other, so that the electrons can only be conducted through the load L, while still allowing for ionic or molecular exchange.

As illustrated in FIG. 1, the fuel cell system 10 also includes an intersection 30 that connects the first fluid passageway 22 with the second fluid passageway 26. A more detailed view of the intersection 30 is shown in FIG. 3. The intersection 30 is arranged so that the anolyte flow containing the oxidation products in the first fluid passageway 22 contacts the catholyte flow containing the reduction products in the second fluid passageway 26 to enable the necessary ionic or molecular exchange between the two flows to complete the reaction. Thus, the overall fuel cell reaction may be characterized by (a) the oxidation of fuel to generate oxidation products and electrons for conduction to the load L, (b) the reduction of the oxidizer supported by receiving electrons from the load L, and (c) the exchange of the oxidized and reduced products at, for example, the intersection 30 to complete the overall reaction. The intersection 30 may also be called an exchange zone because the intersection 30 is the location at which, for example in an acidic fuel cell, the ions are exchanged between the fuel and the oxidizer, although reactions do not necessarily have to occur at the intersection. In embodiments in which ions are exchanged in the exchange zone, the exchange zone may be called an ion exchange zone, although such a term is not intended to be limiting in any way. By-products that are generated may be neutral, but they do not have to be neutral. Although the fluid will be “net-neutral,” the individual species may have charges.

The exchange zone may have a relatively large area to facilitate reaction of the ions so that the resistance of the electrochemical circuit may be reduced, which may maximize potential at each electrode (i.e., at the anode 12 and the cathode 14). Having an area that is too high, however, may result in more diffusive mixing at the intersection 30, as well as flow instabilities, which may disrupt the laminar flows within the first and second fluid passageways 22, 26 or allow cross-over of the reactants.

As illustrated in FIG. 1, the first fluid passageway 22 extends past the intersection 30 such that part of the flow of the anolyte, which includes oxidation products, does not contact the flow of the catholyte, which includes reduction products, and the second fluid passageway 26 extends past the intersection such that part of the flow of the catholyte does not contact the flow of the anolyte. As illustrated, the first fluid passageway 22 and the second fluid passageway 26 intersect again at a further intersection 32 that defines a further exchange zone.

In the illustrated embodiment, six intersections or exchange zones are provided. Of course, more or less intersections may be provided, depending on the application. The intersections or exchanges zones are arranged so that there is intermittent contact between the respective flows within the first and second fluid passageways 22, 26. By arranging the first fluid passageway 22 and the second fluid passageway 26 in this way, the contact area between the two streams (i.e., of anolyte and catholyte) flowing through the passageways 22, 26 may be minimized, but the instances or frequency of contact between the two streams may be increased. This may reduce the overall diffusive mixing effects, maintain a stable flow pattern in each of the passageways 22, 26, and allow for an overall large area for ion exchange. This arrangement may also allow essentially no cross-over of un-reacted fuel and oxidizer from one fluid passageway to the other fluid passageway.

In the embodiment illustrated in FIG. 2, the flow of the anolyte in the first fluid passageway 22 is counter to the flow of the catholyte in the second fluid passageway 26. As shown in FIG. 4, which is a detailed view of an intersection 34 or exchange zone, this configuration may allow the flows in the first fluid passageway 22 and the second fluid passageway 26 to create a small vortex or recirculation zone 36 within the exchange zone. Such a vortex may create a “virtual membrane” for ion transport between the two flows, without allowing depletion of the reactants as a result of substantial cross-over.

In an embodiment, the fuel may be hydrogen saturated sulfuric acid and the oxidant may be oxygen saturated sulfuric acid. For an acidic cell using such reactants, oxidation of the fuel at the anode 12 may be generally represented by the following equation:

H₂→2H⁺+2e⁻ (1)

and reduction of the oxidant (oxidizer) at the cathode 14 may be represented by the following equation:

0.5O₂+2e⁻+2H¹→H₂O (2)

and the net reaction of the system is:

H₂+0.5O₂→H₂O (3)

Thus, the byproduct of these reactions is water.

For an alkaline fuel cell, oxidation of the fuel at the anode 12 may be generally represented by the following equation:

H₂+2OH⁻→2H₂O+2e⁻ (4)

and reduction of the oxidant (oxidizer) at the cathode 14 may be represented by the following equation:

O₂+2H₂O+4e⁻→4OH⁻ (5)

and the net reaction of the system is:

H₂+0.5O₂→H₂O (6)

which is the same net reaction described above in reference to an acidic fuel cell in equation (3).

For either type of fuel cell (i.e., acidic or alkaline), other possible reactions may occur, including various intermediary reactions, or different reactions when different reactants are used. The system generates an open circuit voltage based on the potentials of its respective half cell reactions. When current is drawn through the load L, this voltage will generally decrease in value to zero, the point of maximum extractable current, or short circuit voltage.

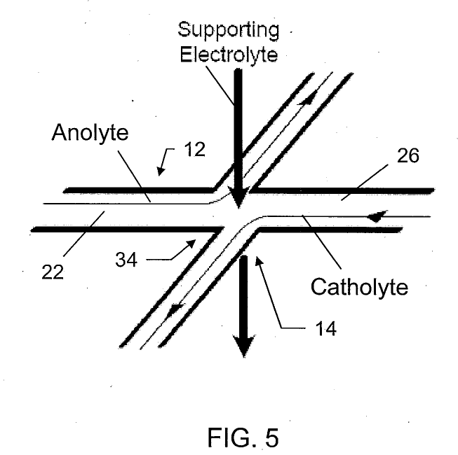

FIG. 5 illustrates an embodiment in which a flow of a supporting electrolyte is provided to the intersection 34. As illustrated, the flow of the supporting electrolyte is provided substantially perpendicular to the flows of the catholyte and anolyte. The supporting electrolyte may be selected to carry any by-product of the reaction of the oxidation products and the reduction products, such as the H₂O of equation (3) above, away from the flow passageways 22, 26 and out of the fuel cell. The supporting electrolyte also replenishes the electrolyte in the exchange zone, which may increase the local conductivity and further reduce Ohmic voltage losses in the cell. Such an embodiment may be particularly useful in a three-dimensional microfluidic fuel cell that includes several layers of flow passageways.

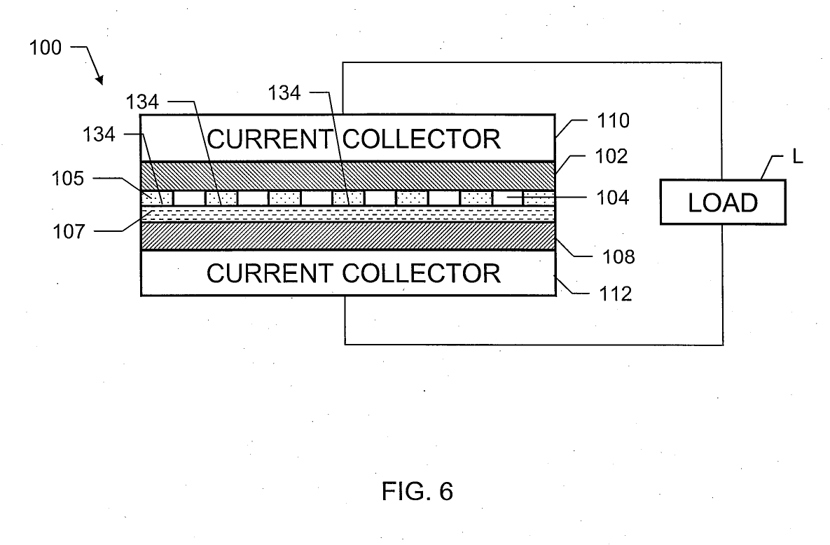

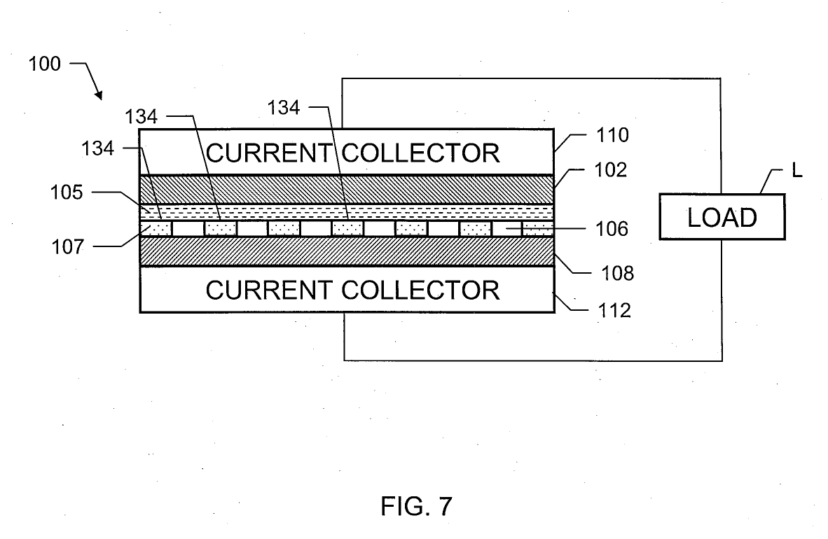

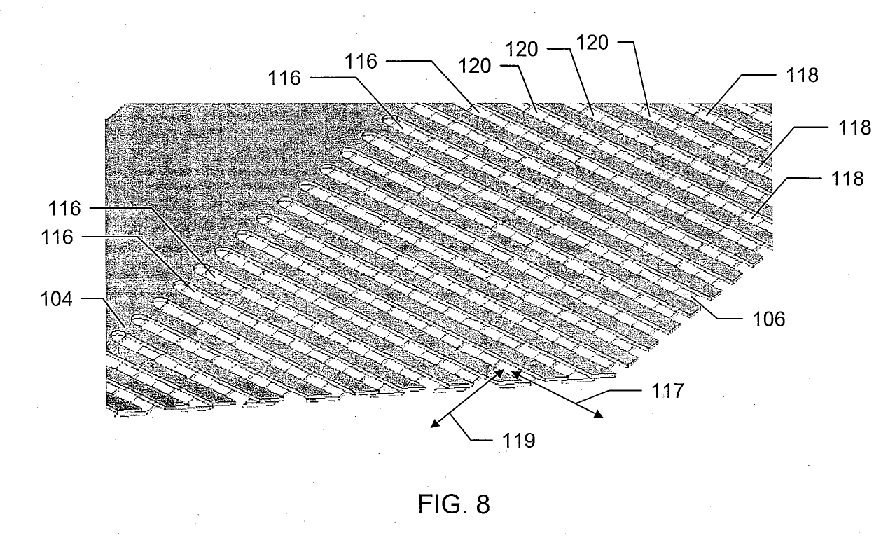

FIGS. 6 and 7 illustrate cross-sectional views of an embodiment of a fuel cell 100. The cross-sectional view of FIG. 7 is about 90° from the cross-sectional view of FIG. 6, as will become more apparent below. The fuel cell 100 includes a plurality of plate-like structures that may be stacked together to form the fuel cell 100. The plate-like structures include a cathode 102, a catholyte flow guide 104 configured to guide a catholyte 105 across the cathode 102, and an anolyte flow guide 106 configured to guide an anolyte 107 across an anode 108. As illustrated, current collectors 110, 112 are placed in contact with the cathode 102 and anode 108, respectively, and are connectable to a load L. The current collectors 110, 112 may also be in the form of plate-like structures, or may have any other suitable structure that allows the current flow between the cathode 102 and the load L, as well as the anode 108 and the load L. These individual fuel cell layers can be stacked offering a compact form factor for increasing power density. A more detailed view of an embodiment of the flow guides 104, 106 is illustrated in FIG. 8 and discussed below.

As shown in FIGS. 6 and 7, the catholyte 105 and the anolyte 107 come into contact with each other at a plurality of discrete locations, i.e., intersections 134. FIG. 7 schematically illustrates the flow of the catholyte 105 and the anolyte 107 within the respective guides 104, 106. The intersections 134 indicate locations at which the catholyte 105 and anolyte 107 are exposed to each other such that ion transport may take place, as discussed above, without the catholyte 105 and anolyte 107 substantially mixing with each other. As such, the intersections 134 may also be referred to as ion transport zones, or ion exchanges zones, because such locations are where the oxidation products and the reduction products react or transport to complete the fuel cell reaction discussed above.

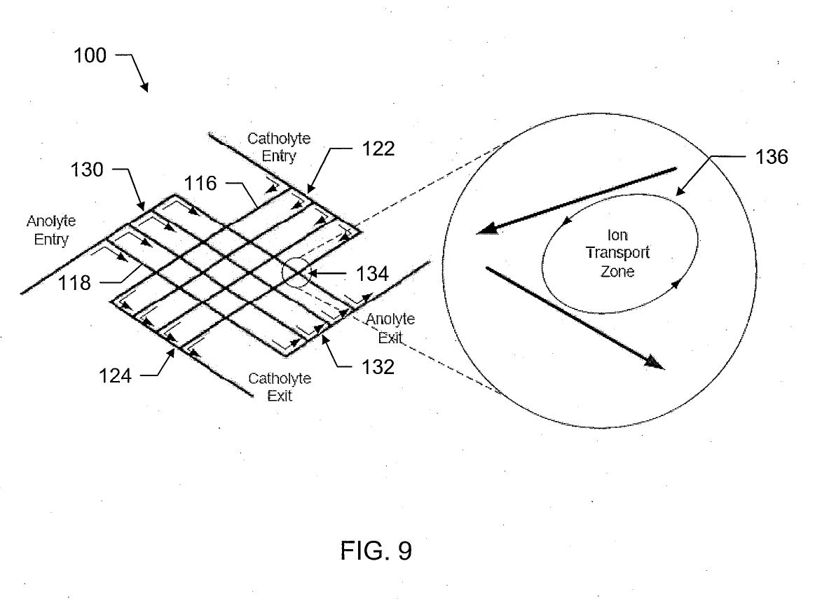

FIG. 8 illustrates an embodiment of the flow guides 104, 106 that may be used to guide flows of the catholyte 105 and anolyte 107, respectively, so that the oxidant and the fuel come into contact at the intersections 114. The flow guides 104, 106 are desirably electrochemically inert and non-conductive so that they may contact each other without contributing to the electrochemical reaction that takes place in the fuel cell 100 or causing any short-circuits within the fuel cell 100. As shown in FIG. 8, the catholyte flow guide 104 may be a plate-like structure that is provided with a plurality of generally parallel slots 116 that are oriented in a first direction 117. As shown in FIG. 9, the anolyte flow guide 106 may also be a plate-like structure that is provided with a plurality of generally parallel slots 118 that are oriented in a second direction 119. In the illustrated embodiment, the first direction 117 and the second direction 119 are substantially perpendicular to each other so that an angle between the first direction and the second direction is about 90°. In other embodiments, the angle defined by the first direction and the second direction may be less than about 90°. For example, in an embodiment, the angle may be between about 5° and about 90°, or about 30° and 60° or about 45°. When one of the flow guides 104 is placed on top of the other flow guide 106, as show in FIG. 8, a plurality of openings 120 are created, which define the intersections 114 illustrated in FIGS. 6 and 7.

The slots 116, 118 of the flow guides 104, 106 create flow channels when the fuel cell is assembled, and may be configured to allow the catholyte 105 and the anolyte 107, respectively, to flow from one end of the slot 116, 118 to the other end of the slot 116, 118 in such a manner that the flows are laminar. In other embodiments, instead of having unitary plate-like structures or grids for the flow guides 104, 106, the slots 116, 118 could be defined by individual members positioned in spaced apart relation.

As illustrated in FIG. 9, a delivery manifold 122 may be connected to each slot 116 in the catholyte flow guide 104 so that the oxidizer may be delivered to each slot 116. The manifold 122 may have any suitable configuration and preferably provides the oxidizer to the slots 116 in such a way that the flow rate in each slot 116 is substantially the same. A flow generator may be connected to the manifold 124 as well as a source of oxidizer and electrolyte to generate the flow rate of the catholyte discussed above. An exit manifold 124 may also be connected to an opposite end of each slot 116 that is connected to the delivery manifold 122. The exit manifold 124 may be connected to a return system (not shown) that is configured to direct the electrolyte to a collector or separator that allows any undesirable by-products to be removed from the electrolyte and any oxidizer or reduced oxidizer to be returned to the delivery manifold 122.

Similarly, a delivery manifold 130, also shown schematically in FIG. 9, may be connected to each slot 118 in the anolyte flow guide 106 so that the fuel may be delivered to each slot 118. The manifold 130 may have any suitable configuration and preferably provides the fuel to the slots 118 in such a way that the flow rate in each slot 118 is substantially the same. A flow generator may be connected to the manifold 130 as well as a source of fuel and electrolyte to generate the flow rate of the anolyte discussed above. An exit manifold 132 may also be connected to an opposite end of each slot 116 that is connected to the delivery manifold 130. The exit manifold 132 may be connected to a return system (not shown) that is configured to direct the electrolyte to a collector or separator that allows any undesirable by-products to be removed from the electrolyte and any unused fuel or oxidant to be returned to the delivery manifold 130.

In the embodiment illustrated in FIG. 9, the direction of the flows of the catholyte and the anolyte may create a small vortex or circulation zone 136 within the ion exchange zone of the intersection 134. As discussed above with respect to FIG. 4, such a vortex may create a virtual membrane for ion or molecular transport between the two flows, without allowing depletion of the reactants by substantial cross-over.

The flow channels created by the slots 116, 118 may span the microfluidic to millifluidic range, i.e., the smallest dimension, such as the depth of the channel, may be in the range of about 1 μm to about 10 mm. The lengths of the channels may be designed so that the most efficient reactant utilization may be achieved, and may depend on the concentrations of the particular reactants in the catholyte and the anolyte. In an embodiment, the length of the channels may be selected within an aspect ratio that is based upon the Peclet number (Pe), as specified by equation (4) below:

Pc=UH/D (4)

where U is the average velocity of the catholyte or anolyte in the channel, which may be controlled by the flow rate, H is the characteristic dimension of the channel (such as the width or height), and D is the diffusion coefficient of the catholyte or anolyte that is flowing in the channel. Preferably, the channel geometry and flow rates are selected so that a high Peclet number, such as greater than 10 is achieved, so as to substantially prevent intermixing of the catholyte and the anolyte at the intersection points, (contact zones).

The cathode 102 may be made out of a catalyst material so that when the cathode 102 is connected to the anode 108 via the load L, the cathode reduces the oxidizer. In an embodiment, the cathode 102 may include a catalyst material that is only on the portions of the surface of the cathode 102 that form walls of the channels defined by the slots 116 and come into contact with the oxidizer and electrolyte (catholyte). Similarly, the anode 108 may be made out of a suitable catalyst material so that when the anode 108 is connected to the cathode 102 via the load L and is in contact with the fuel and electrolyte, the anode 108 oxidizes the fuel. In an embodiment, the anode 108 may include a catalyst material that is only on portions of the surface of the anode 108 that form walls of the channels defined by the slots 118 and come into contact with the fuel and the electrolyte (anolyte).

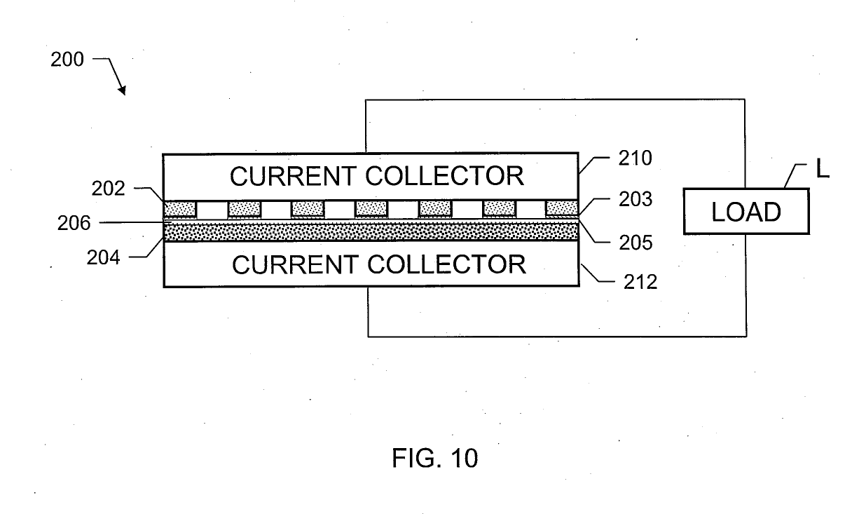

FIG. 10 illustrates an embodiment of a fuel cell 200 in which a cathode 202 and an anode 204 are porous such that a catholyte 203 and an anolyte 205 may flow through the cathode 202 and the anode 204, respectively. In the illustrated embodiment, the cathode 202 and the anode 204 are spaced from each other by a small gap 206, which may serve as an insulator. In an embodiment, the gap 206 may be filled with an electrically insulating, yet ion exchanging medium. Gap 206 may be a porous material or a gap filled with fluid.

The electrodes (i.e., anode and cathode) can be made up of any electrically conductive material that is coated with a suitable catalyst. In an embodiment, each electrode comprises a porous material that is the catalyst itself, including but not limited to a catalyst coated carbon cloth, a porous foam, a packed bed of catalyst particles, and/or colloidal crystals.

In addition to any fuel, oxidant, electrolyte or catalyst material mentioned above, any of the following in various combinations may be used in any of the embodiments described above, as well as in any other embodiment within the scope of any aspect of the invention.

Electrodes/Catalysts: Platinum, Platinum black, Platinized metal (any), Nickel, Nickel Hydroxide, Manganese, Manganese Oxides (all states), Palladium, Platinum Ruthenium alloys, Nickel Zinc alloys, Nickel Copper alloys, Gold, Platinum black supported on metal oxides, Platinum Molybdenum alloys, Platinum Chromium alloys, Platinum Nickel alloys, Platinum Cobalt alloys, Platinum Titanium alloys, Platinum Copper alloys, Platinum Selenium alloys, Platinum Iron alloys, Platinum Manganese alloys, Platinum Tin alloys, Platinum Tantalum alloys, Platinum Vanadium alloys, Platinum Tungsten alloys, Platinum Zinc alloys, Platinum Zirconium alloys, Silver, Silver/Tungsten Carbide, Iron tetramethoxyphenyl porphorin, Carbon or Carbon Black.

Fuels: Formic acid, Methanol, Ethanol, 1-proponal, 2-proponal, Cyclobutanol, Cyclopentanol, Cyclohexanol, Benzyl alcohol, Lithium, Zinc, Aluminum, Magnesium, Iron, Cadmium, Lead, Acetaldehyde, Propionaldehyde, Benzaldehyde, Ethylene glycol, Glyoxal, Glycolic acid, Glyoxylic acid, Oxalic acid, 1,2-propanediol, 1,3-propanediol, Glycerol, Hydrogen, Vandium(II)/Vanadium(III), Carbon Monoxide, Sodium Borohydride, Other Borohydrides (e.g. Potassium), and other metal redox systems e.g.: Iron/chromium, Nickel/cadmium.

Oxidants: Air, Oxygen gas, Dissolved Oxygen, Hydrogen Peroxide, Potassium Permanganate, Vanadium(IV)/Vanadium(V) and Manganese Oxide.

Electrolytes: Potassium Hydroxide, Sodium Hydroxide, Sulfuric acid, Nitric acid, Formic acid, Phosphoric acid, Trifluoromethanesulfonic acid (TFMSA), Ionic liquids (all types), Acetimide, Fluoroalcohol emulsions, and Perflourocarbon emulsions (e.g. Flourinert®).

The foregoing illustrated embodiment(s) have been provided solely for illustrating the structural and functional principles of the present invention and are not intended to be limiting. To the contrary, the present invention is intended to encompass all modifications, substitutions, alterations, and equivalents within the spirit and scope of the following appended claims.

1. A method for generating electrical current using a fuel cell comprising an anode, a cathode, a first flow channel associated with the anode, a second flow channel associated with the cathode, and a plurality of spaced apart exchange zones wherein the first and second flow channels are open to one another, the method comprising:
flowing a first flow comprising a fuel and a first electrolyte through the first channel, the fuel being oxidized at the anode to generate electrons for conduction to a load and oxidation products in the first flow;
flowing a second flow comprising an oxidizer and a second electrolyte through the second channel, the cathode receiving electrons from the load and the oxidation products, and the oxidizer being reduced to form reduction products and complete an electrochemical circuit;
wherein the plurality of exchange zones are positioned and the flows are oriented within their respective first and second channels such that the first and second flows contact one another intermittently at the exchange zones to enable transport of the reduction and oxidation products to the anode and the cathode.

2. The method according to claim 1, wherein the first flow flows along the anode and the second flow flows along the cathode.

3. The method according to claim 1, wherein the anode and the cathode are porous, and wherein the first flow flows through the anode and the second flow flows through the cathode.

4. The method according to claim 1, wherein the anode and the cathode each comprise a catalyst.

5. The method according to claim 1, wherein the anode and the cathode are electrically conductive.

6. The method according to claim 1, wherein the first flow flows in a direction that is different from a direction of the second flow.

7. The method according to claim 6, wherein the direction of the first flow is substantially opposite the direction of the second flow.

8. The method according to claim 6, wherein the direction of the first flow is about 90° from the direction of the second flow.

9. The method according to claim 1, wherein when the first flow and the second flow contact each other in the exchange zone, and wherein a portion of the first flow and a portion of the second flow shear and cause fluid rotation at an interface between the first flow and the second flow.

10. The method according to claim 9, wherein the exchange zone comprises a non-conductive porous material configured to electrically isolate the anode and the cathode from each other.

11. The method according to claim 1, wherein the first flow is a laminar flow and the second flow is a laminar flow.

12. The method according to claim 1, further comprising supplying a supporting electrolyte to the exchange zones and transporting a reaction by-product away from the exchange zones and/or delivering fresh supporting electrolyte to the exchange zones.

13. The method according to claim 1, wherein the fuel is selected from the group consisting of hydrogen, methanol, ethanol, carboxyl acid, borohydride, and vanadium.

14. The method according to claim 1, wherein the oxidizer is selected from the group consisting of nitric acid, peroxide, permanganate, and vanadium oxide.

15. The method according to claim 1, wherein the electrolyte is selected from the group consisting of sulfuric acid, organic buffer, and hydroxide.

16. A fuel cell comprising:
an anode configured to be connected to a load;
a cathode configured to be connected to the load;
a first flow channel associated with the anode, and configured to receive a flow of a fuel and a first electrolyte so that, in use, the fuel is oxidized by the anode to generate electrons for conduction to the load and oxidation products in the first electrolyte;
a second flow channel associated with the cathode, and configured to receive a flow of an oxidizer and a second electrolyte so that, in use, the oxidizer is reduced by its reaction with the oxidation products and incoming flux of electrons from the load to form reduction products in the second electrolyte; and
a plurality of spaced apart exchange zones wherein the first and second flow channels are open to one another,
wherein the first and second flow channels are oriented such that the flow of the oxidation products and first electrolyte and the flow of the reduction products and the second electrolyte within their respective first and second channels contact one another intermittently.

17. The fuel cell according to claim 16, wherein the first channel is configured to alter the flow of the oxidation products and the first electrolyte at the exchange zones.

18. The fuel cell according to claim 17, wherein the second channel is configured to alter the flow of the reduction products and the second electrolyte at the exchange zones.

19. The fuel cell according to claim 16, wherein the second channel is configured to alter the flow of the reduction products and the second electrolyte at the exchange zones.

20. The fuel cell according to claim 16, wherein the first channel extends past a first exchange zone such that part of the flow of the oxidation products and the first electrolyte does not contact the flow of the reduction products and the second electrolyte until the flows reach a second exchange zone, and the second channel extends past the first exchange zone such part of the flow of the reduction products and the second electrolyte does not contact the flow of the oxidation products and the first electrolyte until the flows reach the second exchange zone.

21. The fuel cell according to claim 16, wherein the first channel, the second channel, and the exchange zones lie in substantially the same plane.

22. The fuel cell according to claim 16, wherein the fuel cell comprises multiple layers that are stacked to increase power density.

23. The fuel cell according to claim 22, wherein a first layer comprises the anode, and a second layer comprises the cathode.

24. The fuel cell according to claim 23, wherein a third layer comprises the first flow channel.

25. The fuel cell according to claim 24, wherein a fourth layer comprises the second flow channel.

26. The fuel cell according to claim 16, further comprising a plurality of first channels defined by a plurality of first slots substantially parallel to one another in a first plate, and a plurality of second channels defined by a plurality of second slots substantially parallel to one another in a second plate, the first plate and the second plate being stacked such that the first slots and the second slots are oriented at an angle from each other, and wherein the exchange zones are located at openings created by overlapping of the first slots and the second slots.

27. The fuel cell according to claim 26, wherein the angle is about 90°.

28. The fuel cell according to claim 26, wherein multiple layers are stacked to increase power density.

29. The fuel cell according to claim 16, wherein the fuel is selected from the group consisting of hydrogen, methanol, ethanol, carboxyl acid, borohydride, and vanadium.

30. The fuel cell according to claim 16, wherein the oxidizer is selected from the group consisting of nitric acid, peroxide, permanganate, and vanadium oxide.

31. The fuel cell according to claim 16, wherein the electrolyte is selected from the group consisting of sulfuric acid, organic buffer, and hydroxide.

32. The fuel cell according to claim 16, wherein the anode and the cathode are at least partially porous, wherein the first fluid channel is defined by the anode so that in use the fuel and the first electrolyte flow through the anode, and wherein the second fluid channel is defined by the cathode so that in use the oxidizer and the second electrolyte flow through the cathode.

33. The fuel cell according to claim 32, wherein the anode and/or the cathode comprises a catalyst coated porous foam, a packed bed of particles, or colloidal crystals.

34. The fuel cell according to claim 16, wherein each exchange zone comprises a non-conductive porous material configured to electrically isolate the anode and the cathode from each other.

35. The fuel cell according to claim 16, wherein the anode and the cathode each comprise a catalyst.

36. The fuel cell according to claim 16, wherein the anode and the cathode are electrically conductive.
